(19) United States
(12) Patent Application Publication
(10) Pub. No.: US 2016/0293168 A1
(43) Pub. Date: Oct. 6, 2016

(54) METHOD OF SETTING PERSONAL WAKE-UP WORD BY TEXT FOR VOICE CONTROL

(71) Applicant: Opah Intelligence Ltd., Taipei City (TW)

(72) Inventor: Yu-Wei CHEN, New Taipei City (TW)

(73) Assignee: Opah Intelligence Ltd., Taipei City (TW)

(21) Appl. No.: 15/075,261

(22) Filed: Mar. 21, 2016

(30) Foreign Application Priority Data
Mar. 30, 2015 (TW) 104110201

(51) Int. Cl. G10L 17/22; G06F 17/27

(52) U.S. Cl. CPC G10L 17/22; G06F 17/2725; G10L 2015/223

(57) ABSTRACT

The present invention is to provide a method of setting personal wake-up word by text for voice control, which enables an electronic device to execute the steps of activating an wake-up-word set program; receiving a set message transmitted from an input unit; parsing a first text information contained in the set message and including at least one character; storing the at least one character as a personal wake-up word; and setting the personal wake-up word as a voice command for activating the voice control program when the at least one character is determined to exist in content of a voice database. Thus, a user can customize the personal wake-up word simply and quickly by inputting the text through the input unit to generate the set message, and later speak a voice corresponding to the personal wake-up word to activate the voice control program for voice control of the electronic device.

### FIELD OF THE INVENTION

The present disclosure generally relates to a method of voice control, more particularly to a method of setting a personal wake-up word by text for voice control, so that a user can customize the personal wake-up word simply, quickly and conveniently by just inputting the text through an input unit to generate the set message, and later speak the voice corresponding to the personal wake-up word to activate a voice control program for voice control of an electronic device.

### BACKGROUND OF THE INVENTION

In recent years, with rapid development of computer, network technology and miniaturization trend of computer hardware, computers have wider application levels expanding from work places to basic necessities of daily life, such as mobile platforms emerged from those conventional computers. For example, the new types of computers can be smart devices including a smartphone, a tablet computer, smart wearable device and so on. The new types of computers facilitate people to handle affair in daily life and to work conveniently and efficiently, so then people grew more dependently on these smart devices. It is obvious that the smart devices have decisive influence for the people's life and work in the foreseeable future.

The smartphone is taken as an as example for illustration. In order to meet the miniaturization trend and demand for a large-sized screen at the same time, the manufacturer removes a conventional keyboard from the smartphone, but it causes that the user difficultly operates the smartphone by two hands as smoothly as using a conventional computer keyboard. While holding the smartphone, the user must make a finger (such as, a thumb) for subsequent operation, and it is very inconvenient for the user to operate the smartphone. In order to solve the above-mentioned problem, manufacturers develop voice control technology which is more close to and meets the person's the daily operation, that is, the user is not required to learn, memorize or get used to the new operation and rules and can just make natural voice to operate or control the smartphone to execute a command corresponding to the natural voice, so as to accomplish various operations including data search, weather inquiry, calendar setting, or alarm clock setting. An intelligent software assistant installed in a current system of the smartphone can implement above-described voice control, for example, Siri of iOS system of Apple's smartphone and Google Now of Android system.

Generally speaking, the voice assistant program (such as the Siri of Apple's smartphone) is not activated until the user speaks a standard wake-up word (such as “Siri”) assigned by the manufacturer to the smartphone, and the activated voice assistant program starts to provide the voice assistant service. In the wake-up procedure, the smartphone mainly uses natural language processing (NLP) technology to convert the user's the natural voice into audio data, and then compares the converted audio data with the audio data of the preset standard wake-up word (such as “Siri”). If difference between the two audio data is within a tolerable error range, the wake-up command corresponding to the preset standard voice is executed to wake up the voice assistant program.

However, the way of using the standard wake-up word to wake up the voice assistant program cannot meet customization requirement in market. Apart from the mobile phone owner, other person can also speak the standard wake-up word to wake up the voice assistant program and control/execute the program in the mobile phone by the above-mentioned way, which easily results in danger of outflow of personal data stored in the mobile phone. Some manufacturers also provide the user to set a personal wake-up word for waking up the voice assistant program. In the process of setting the wake-up word, the user speaks voice of the personal wake-up word (such as “Zhang Daqian”), and the voice is set and stored in the smartphone as the customized personal wake-up word. When the user speaks the wake-up word (such as “Zhang Daqian”) again, the smartphone compares the audio data of the wake-up word and the audio data of the stored personal wake-up word (such as “Zhang Daqian”), and if the difference between the two audio data is within the tolerable error range, the smartphone executes the wake-up command to wake up the voice assistant program.

However, in practice, the user is suggested to stay at quiet and windless environment for recording the personal wake-up word, and the variation in intonation, audio frequency, waveform or punctuation of the personal wake-up word may increase difficulty in interpretation and comparison of the personal wake-up word. The user must repeatedly record the personal wake-up word more time 3 times to preclude or reduce the variations, so as to ensure the natural language processing technology to accurately recognize the personal wake-up word. It is obviously that the difficulty and complexity for user to set personal wake-up word is greatly increased, and the whole modification process is cumbersome and lengthy. Moreover, the background noise exists during setting of the personal wake-up word is often excessively different from the background noise when the user desires to wake up the voice assistant program, which results in the error between the two audio data beyond the tolerable error range, and failure in recognition of the natural language processing technology. Therefore, in the conventional operation method, the user often fails to wake up the voice assistant program by the personal wake-up word, and has greatly reduced willingness to use.

How to improve the conventional operating method for activating the voice assistant program to solve aforesaid problem is an important topic of the present disclosure.

### SUMMARY OF THE INVENTION

In order to solve the problems occurred during the conventional operation method of activating the voice assistant program, the inventor designs a method of setting the personal wake-up word by text for voice control, based on long-term practical experience and multiple experiments and tests.

An objective of the present disclosure is to provide a method of setting the personal wake-up word by text for voice control, the method is applied to an electronic device including a processing unit, a storage unit, an input unit, a voice recognition unit and a voice receiving unit. The storage unit is configured to store a voice control program, a wake-up-word set program, a preset wake-up word and a voice database. The method includes following steps: activating the wake-up-word set program stored in the storage unit, by the processing unit of the electronic device; receiving a set message transmitted from the input unit, by the processing unit; parsing first text information contained in the set message by the processing unit, and the first text information including at least one character; storing the at least one character as a personal wake-up word, by the processing unit; setting the personal wake-up word as a voice command for activating the voice control program when the at least one character of the first text information is determined to exist in content of the voice database by the processing unit; upon receipt of a voice message from the voice receiving unit, parsing the voice message and converting the content of the voice message into second text information by the voice recognition unit, and the second text information including at least one character; by the processing unit, receiving the second text information transmitted from the voice recognition unit; activating the voice control program stored in the storage unit when the processing unit determines that the content of the second text information matches the personal wake-up word, so as to execute a control process corresponding to the voice message received subsequently.

By means of technology of the present disclosure, the user can customize the personal wake-up word simply, quickly and conveniently by just inputting the text through the input unit to generate the set message, and later speak the voice corresponding to the personal wake-up word to activate the voice control program for voice control of the electronic device. Compared with the conventional technology that the user cannot customize the personal wake-up word and only can activate the voice control program by the preset wake-up word, the technology of the present disclosure can meet the customization requirement in market and prevent from the condition that other person can also activate the voice control program by the preset wake-up word. Moreover, compared with the conventional technology that the user must use the voice message to customize the personal wake-up word, in the method of the present disclosure the user does not need to repeatedly record the personal wake-up word more than three times in specifically-selected environment, so that the difficulty and complexity of the user's operation can be greatly reduced, and the modification process is very simple, easy and quick. In addition, the voice recognition unit compares the voice message with the standard voices stored in the voice database rather than the recorded voice of the wake-up word of the conventional technology, so the voice recognition of the personal wake-up word of the present disclosure can be greatly avoided from the interference of background noise in recording environment, and the recognition accuracy of the personal wake-up word can be effectively improved to more smoothly activate the voice control program and the user has more willingness to use.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a block diagram of an electronic device of the present disclosure.

FIG. 2 is a flowchart of a method of the present disclosure, wherein FIG. 2 is composed of FIG. 2A and FIG. 2B joined together by the connector A.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

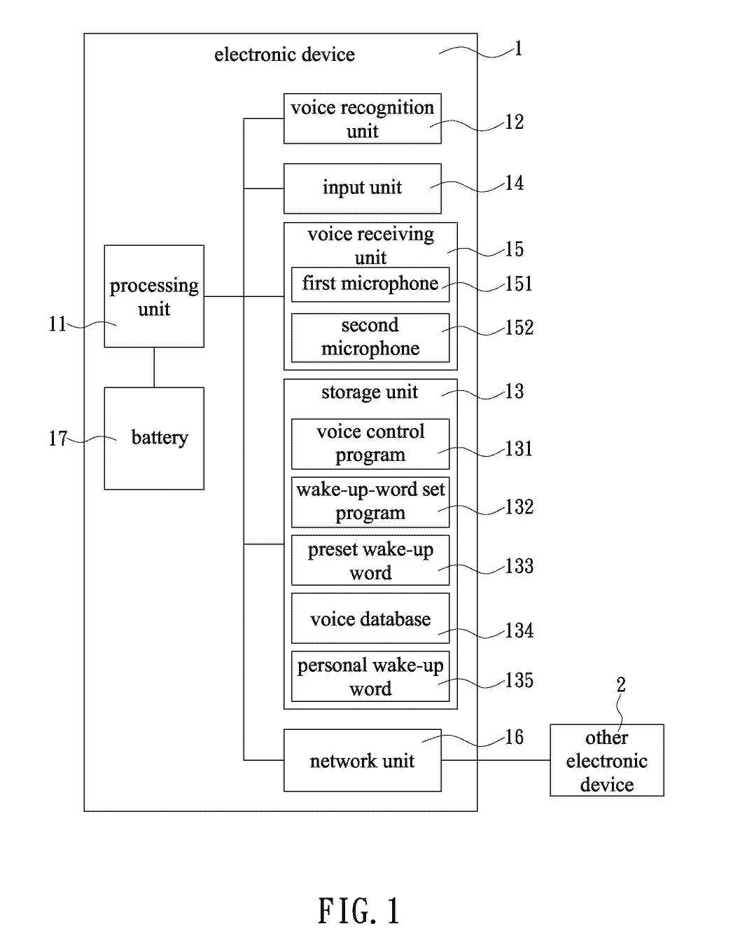

The present disclosure provides a method of setting a wake-up word by text for voice control. Please refer to FIG. 1. In a preferred embodiment of the present disclosure, the method is applied to an electronic device 1 (such as a smartphone, a tablet computer, a wearable device and so on) including a processing unit 11, a voice recognition unit 12, a storage unit 13, an input unit 14 (such as a keyboard, a touch pad and so on), a voice receiving unit 15 and a battery 17. The storage unit 13 is configured to store a voice control program 131 (such as, intelligent software assistant), a wake-up-word set program 132, a preset wake-up word 133 and a voice database 134. The processing unit 11 is respectively electrically connected to the battery 17, the voice recognition unit 12, the storage unit 13, the input unit 14 and the voice receiving unit 15, and configured to switch the battery 17 to supply power to the units 12 through 15 and control turn-on/off of the units 12 through 15, and receive a message transmitted from the voice receiving unit 15, the input unit 14 and the voice recognition unit 12 by the electric connection between the units 12 through 15, access the data stored in the storage unit 13 for subsequent process, and activate the program stored in the storage unit 13 to execute relevant process. The voice database stores a plurality of standard voices, text corresponding to the plurality of standard voices and a look-up table. The look-up table records relationships between the plurality of standard voices and text, and after the voice recognition unit 12 completes the comparison for the input voice, the input voice can be converted into corresponding text based on the look-up table.

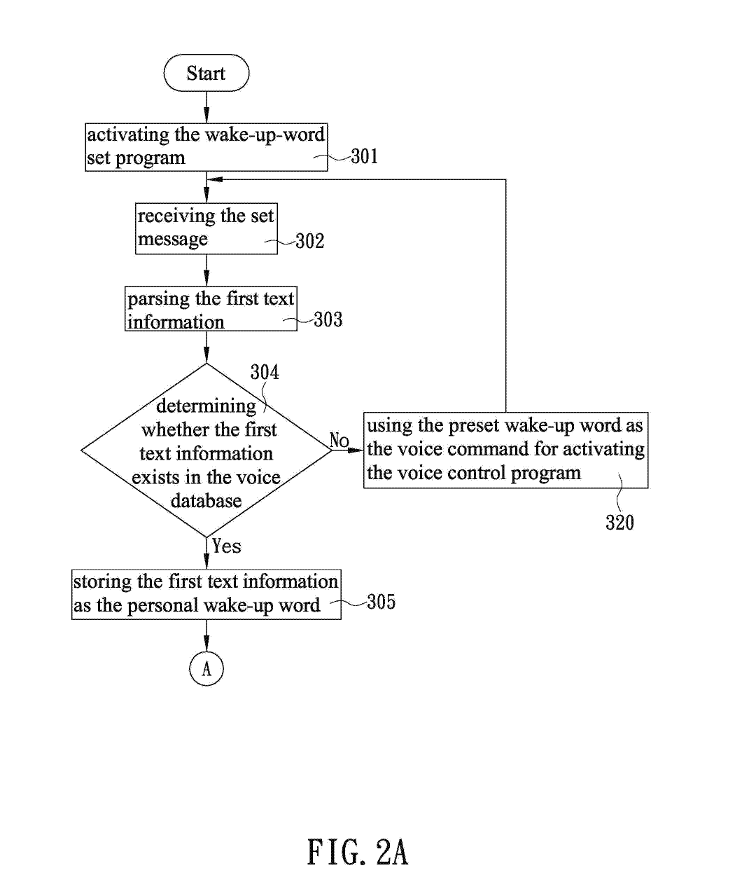

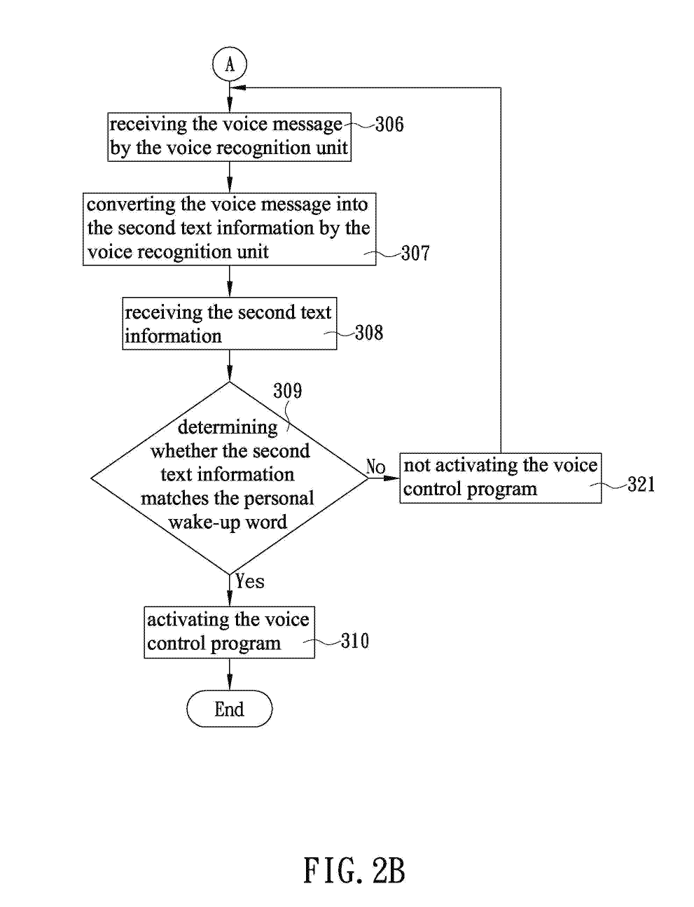

The method of the preferred embodiment of the present disclosure will be illustrated in detail below. Please refer to FIGS. 1, 2A and 2B. In the method, the electronic device 1 executes following steps.

Step (301): activating the wake-up-word set program 132.

Step (302) receiving the set message. In the present embodiment, the set message is transmitted from the input unit 14 by which the user inputs the text.

Step (303): parsing the first text information contained in the set message. The first text information contains at least one character (that is, a Chinese character or an English character such as “Zhang Daqian”).

Step (304): determining whether the at least one character (such as “Zhang”, “Da” and “qian”) exists in the content of the voice database 134, and if the at least one character exists in the content of the voice database 134, proceeding step 305; otherwise, proceeding step (320).

Step (305): storing the at least one character (such as “Zhang Daqian”) as the personal wake-up word 135, and using the personal wake-up word 135 as the voice command for activating the voice control program 131.

Step (306): parsing the voice message by the voice recognition unit 12 when the voice recognition unit 12 receives the voice message transmitted from the voice receiving unit 15.

Step (307): converting the content of the voice message (such as voice of “Zhang Daqian”) into the second text information by the voice recognition unit 12 based on the content of the voice database 134. The second text information contains at least one character (that is, the Chinese character or the English character, such as “Zhang Daqian”).

Step (308): receiving the second text information transmitted from the voice recognition unit 12.

Step (309): determining whether the content of the second text information matches the personal wake-up word 135, and if the content of the second text information matches the personal wake-up word 135, proceeding step (310); otherwise, proceeding step (321).

Step (310): activating the voice control program 131 and executing the control process corresponding to the voice message subsequently received from the voice receiving unit 15.

Step (320): using the preset wake-up word 133 as the voice command for activating the voice control program 131, and returning to the step (302).

Step (321): not activating the voice control program 131, not executing the control process corresponding to the voice message subsequently received from the voice receiving unit 15, and returning to the step (306).

Therefore, by just inputting the text through the input unit 14 to generate the set message, the user can quickly and conveniently set the personal wake-up word 135 and activate the voice control program 131 based on the voice corresponding to the personal wake-up word 135, so as to control the electronic device 1 by voice subsequently.

Please refer back to FIGS. 1, 2A and 2B. In other preferred embodiment of the present disclosure, the electronic device electronic device further includes a network unit 16 electrically connected to the processing unit 11. In this preferred embodiment, when the electronic device 1 proceeds the step (302) shown in FIG. 2A, the set message can also be transmitted from other electronic device 2 through the network unit 16. Therefore, apart from modifying the personal wake-up word 135 through the input unit 14 of the electronic device 1, the user can also modify the personal wake-up word 135 of the electronic device 1 through the other electronic device 2. In this embodiment, it should be noted that the other electronic device 2 can be electrically interconnected to the network unit 16 of the electronic device 1 by wired or wireless network.

In addition, as shown in FIG. 1, the voice receiving unit 15 includes a first microphone 151 and a second microphone 152. The first microphone 151 is configured to continuously receive the voice message for activating the voice control program 131, and when the voice control program 131 is activated, the second microphone 152 is turned on to receive the voice message for subsequently controlling the voice control program 131 to execute the corresponding control process. The voice message for activating the voice control program 131 is shorter and simpler than the voice message for subsequently controlling the voice control program 131 to execute the corresponding control process, so in this embodiment the voice receiving unit 15 is separated into the first microphone 151 and the second microphone 152 which have different voice receiving performances and power consumptions in respectively receiving the voice messages with different complexities and operating for different lengths of time and different timing, whereby the power consumption of the electronic device 1 can be greatly reduced and the user can more effectively and reliably activate the voice control program 131 by voice, or control the voice control program to execute the corresponding control process by voice.

In conclusion, compared with the convention technology that the user cannot customize the personal wake-up word 135 and only use the preset wake-up word 133 to activate the voice control program 131, the method of the present disclosure can meet the customization requirement in market and prevent the voice control program 131 from being activated by the other person using the preset wake-up word 133. Moreover, compared with the conventional technology that the user must use the voice message to customize the personal wake-up word 135, in the method of the present disclosure the user does not need to repeatedly record the personal wake-up word 135 more than three times in specifically-selected environment, so that the difficulty and complexity of the user's operation can be greatly reduced, and the modification process can be very simple, easy and quick. In addition, the voice recognition unit 12 compares the voice message with the standard voices stored in the voice database 134 rather than the recorded voice of the wake-up word in the conventional technology, so the voice recognition of the personal wake-up word 135 of the present disclosure can be greatly avoided from the interference of background noise in recording environment, and the recognition accuracy of the personal wake-up word 135 can be effectively improved to more smoothly activate the voice control program 131 and the user has more willingness to use.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method of setting a personal wake-up word by text for voice control, which is applied to an electronic device comprising a processing unit, a storage unit, an input unit, a voice recognition unit and a voice receiving unit, wherein the storage unit is configured to store a voice control program, a wake-up-word set program, a preset wake-up word and a voice database, and the method comprises steps of:
activating the wake-up-word set program stored in the storage unit by the processing unit of the electronic device;
receiving a set message transmitted from the input unit by the processing unit;
parsing first text information contained in the set message by the processing unit, wherein the first text information comprises at least one character;
storing the at least one character as a personal wake-up word by the processing unit;
setting the personal wake-up word as a voice command for activating the voice control program when the at least one character of the first text information is determined to exist in content of the voice database by the processing unit;
upon receipt of a voice message from the voice receiving unit, parsing the voice message and converting the content of the voice message into second text information by the voice recognition unit, wherein the second text information comprises at least one character;
receiving the second text information transmitted from the voice recognition unit by the processing unit; and
when the content of the second text information is determined to match the personal wake-up word, activating the voice control program stored in the storage unit and executing a control process corresponding to the voice message received subsequently by the processing unit.

2. The method according to claim 1, wherein the electronic device further comprises a network unit configured to receive the set message transmitted from other electronic device, so as to enable the personal wake-up word in the electronic device to be set through the other electronic device.

3. The method according to claim 1, wherein the voice receiving unit comprises a first microphone and a second microphone, the first microphone is configured to continuously receive the voice message for activating the voice control program and, when the voice control program is activated, the second microphone is turned on to receive the voice message for subsequently controlling the voice control program to execute the control process.

4. The method according to claim 2, wherein the voice receiving unit comprises a first microphone and a second microphone, the first microphone is configured to continuously receive the voice message for activating the voice control program and, when the voice control program is activated, the second microphone is turned on to receive the voice message for subsequently controlling the voice control program to execute the control process.

5. The method according to claim 3, further comprising:
under a condition that the processing unit accomplishes parsing the first text information of the set message and determines that the at least one character of the first text information does not exist in the voice database, using the preset wake-up word as the voice command for activating the voice control program by the processing unit.

6. The method according to claim 4, further comprising:
under a condition that the processing unit accomplishes parsing the first text information of the set message and determines that the at least one character of the first text information does not exist in the voice database, using the preset wake-up word as the voice command for activating the voice control program by the processing unit.

7. The method according to claim 5, further comprising:
under a condition that the processing unit receives the second text information transmitted from the voice recognition unit and determines that the content of the second text information does not match the personal wake-up word, not activating the voice control program by the processing unit.

8. The method according to claim 6, further comprising:
under a condition that the processing unit receives the second text information transmitted from the voice recognition unit and determines that the content of the second text information does not match the personal wake-up word, not activating the voice control program by the processing unit.
